(19) United States
(12) Patent Application Publication
(10) Pub. No.: US 2007/0151651 A1
(43) Pub. Date: Jul. 5, 2007

(54) Media gap detection by reflective florescence

(75) Inventors: Peter Gustafsson, Kallered (SE); Mats Hedberg, Varberg (SE)

Correspondence Address: SEED INTELLECTUAL PROPERTY LAW GROUP PLLC, 701 FIFTH AVENUE, SUITE 5400, SEATTLE, WA, 98104-7092, US

(73) Assignee: Intermec IP Corp., Everett, WA (US)

(21) Appl. No.: 11/589,327

(22) Filed: Oct. 27, 2006

Related U.S. Application Data
(63) Continuation of application No. 11/365,479, filed on Mar. 1, 2006.
(60) Provisional application No. 60/658,059, filed on Mar. 1, 2005.

(51) Int. Cl. B65C 9/40; B65C 9/42

(52) U.S. Cl. 156/64; 156/277

(57) ABSTRACT

A method of gap detection between successive adhesive layers on a media carrier using reflective florescence. Roll of label media is obtained and placed on a printer (not shown). Labels pass by a UV light source and labels and carrier reflect back a portion of the UV light. The reflected light is detected by a photosensor. The difference in florescence between label and carrier is detected. Location of the change of florescence identifies the location of the beginning of gap/end of label or the end of gap/beginning of label. The printer is adjusted if necessary to ensure any markings, printing, logos, symbologies or other indicia is printed in the correct position on label.

### CROSS-REFERENCES TO RELATED APPLICATIONS

This application is a continuation of U.S. patent application Ser. No. 11/365,479, filed Mar. 1, 2006, now pending, which claims the benefit of U.S. Provisional Application No. 60/658,059, filed Mar. 1, 2005 entitled Media Gap Detection by Reflective Florescence.

### BACKGROUND OF THE INVENTION

1. Field of Invention

The present invention relates to a reflective florescence used for gap detection of adhesive labels on a media carrier.

2. Description of Related Art

Current methods to detect gaps use transparency differences between the label and the carrier. The transparency difference between label and carrier must be large enough to be accurately detected, resulting in a minimum thickness of label and a maximum thickness of carrier.

There is a need for a method of gap detection that allows for a larger variety of labels to be manufactured without the restrictions created by current gap detection techniques.

### SUMMARY OF THE INVENTION

An embodiment includes a method of gap detection between successive adhesive layers on a media carrier using reflective florescence. A roll of label media is obtained and placed on a printer. The label roll includes labels carried by a carrier. The labels and carrier pass by a UV light source, and the labels and carrier reflect back a portion of the UV light. The reflected light is detected by a photosensor.

The difference in florescence between a label and the carrier is detected. The location of the change of florescence identifies the location of the beginning of gap/end of label or the end of gap/beginning of label. The printer is adjusted, if necessary, to ensure any markings, printing, logos, symbologies or other indicia is printed in the correct position on label.

Media thickness of both the label and the carrier can be reduced, thus increasing number of labels that can be wound on a roll. In addition, carrier quality can be reduced as transparency is not used. This allows use of recycled paper for carrier material.

### BRIEF DESCRIPTION OF THE DRAWINGS

FIG. 1 is a flow chart of a method of gap detection according to one illustrated embodiment.

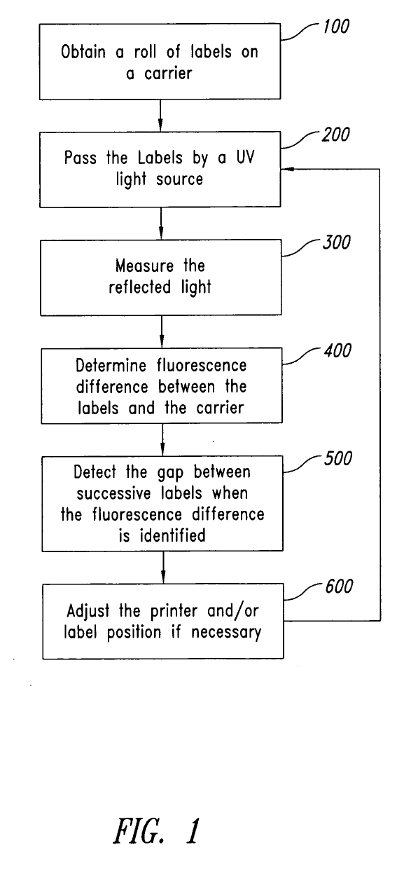

FIG. 2 is a schematic of a gap detection system according to one illustrated embodiment.

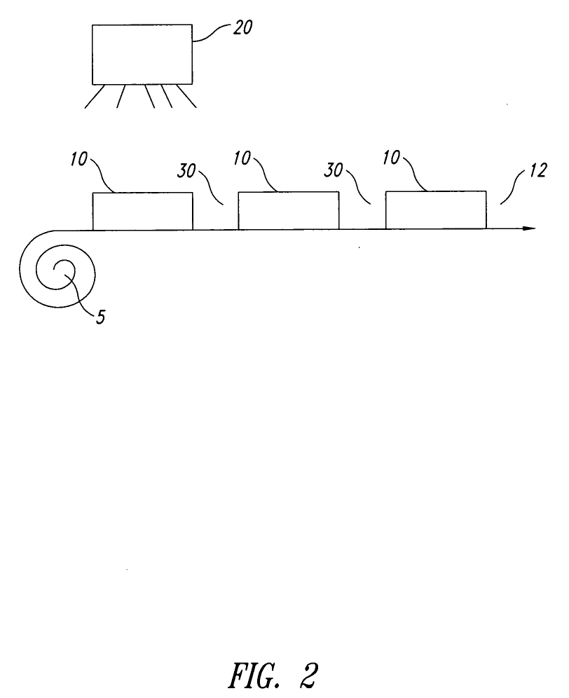

### DETAILED DESCRIPTION OF THE INVENTION

Typically, a label roll 5 comprises a plurality of labels 10 on carrier 12. There is gap 30 between each successive label 10. The roll of labels 5 is placed on a printer (not shown). Labels 10 are typically cladded with a chalk and kaolin mixture to enhance the apparent whiteness of paper. This mixture also has a high degree of florescence.

A combined light source/detector 20 illuminates labels 10 and carrier 12 with UV light and measures the light from the media 10, 12 passing by the combined light source/detector 20. The combined light source/detector 20 includes a UV-emitting source that is preferably combined with a visual light sensitive detector. A UV emitting light source is preferably a light emitting diode light source. A visual light sensitive detector preferably utilizes a phototransistor to measure reflected light. Alternatively, a light source and a separate detector could be used.

Media 10, 12 pass by the combined light source/detector 20 and are illuminated by a UV light. The visual light sensitive detector of the combined light source/detector 20 measures the light from the media 10, 12. The detector of the combined light source/detector 20 measures the florescence or reflectivity difference between labels 10 and carrier 12. The florescence difference between cladded/coated label 10 and un-cladded/uncoated carrier 12 causes a light difference in the visual spectrum, which is identified by detector 20 and used for to determine the location of gap 30 and/or of label 10. Thus, gaps 30 between successive labels 10 and/or the position of each successive label 10 is detected and identified. If necessary, printer (not shown) can then be adjusted so that each label 10 is printed in the appropriate position on the label 10.

At 100, a roll of label media is obtained and placed on a printer (not shown).

At 200, the labels of the label media pass by a UV light source, and the labels and the carrier of the label media reflect back a portion of the UV light.

At 300, the light from the labels and carrier is detected by a photosensor.

At 400, the difference in florescence between label and carrier is detected.

At 500, the location of the change of florescence identifies the location of the beginning of gap/end of label or the end of gap/beginning of label.

At 600, the printer is adjusted, if necessary, to ensure any markings, printing, logos, symbologies or other indicia is printed in the correct position on label.

Using the florescence difference between the label and carrier allows thickness of both the label and the carrier to be reduced, thus increasing number of labels that can be wound on a roll. In addition, carrier quality can be reduced as transparency is not used. This allows use of recycled paper for carrier material.

1. A method of determining label position comprising the steps of:
obtaining a roll of label media;
passing the label media by a light source;
detecting the reflected light;
determining the location of differences in florescence; and
identifying the location of the beginning of gap/end of label and/or the end of gap/beginning of label.

2. The method of claim 1 further comprising the step of adjusting the printer and/or the label position.
